(19) United States
(12) Patent Application Publication
(10) Pub. No.: US 2026/0061928 A1
(43) Pub. Date: Mar. 5, 2026

(54) RETRACTABLE HANDRAIL

(71) Applicant: Stromberg-Carlson Products, Inc., Traverse City, MI (US)

(72) Inventors: Robert Brammer, JR., Traverse City, MI (US); Caleb Vainikka, Hanover, MN (US)

(21) Appl. No.: 19/312,433

(22) Filed: Aug. 28, 2025

Related U.S. Application Data
(60) Provisional application No. 63/690,030, filed on Sep. 3, 2024.
(60) Provisional application No. 63/760,740, filed on Feb. 20, 2025.

(51) Int. Cl. B60P 3/36

(52) U.S. Cl. CPC B60P 3/36

(57) ABSTRACT

A retractable handrail comprising a rail assembly including a rail rod, an upper pivot assembly connected to the rail rod, a lower pivot assembly, and a support shaft pivotally connected to the lower pivot assembly. The support shaft including a slider configured to slide within the rail assembly. Rotating the rail rod about the upper pivot assembly causes the slider to slide along the rail rod, thereby causing the support shaft to rotate about the lower pivot assembly. The lower pivot assembly including a fixed part and a movable part. The lower pivot assembly can include grip arms to grip the support shaft, the movable part can be stepped, and the movable part can have two interlocking connection blocks and the fixed part can include a single interlocking connection block between the two interlocking connection blocks of the movable part.

### CROSS REFERENCE TO RELATED APPLICATIONS

This claims the benefit of U.S. Provisional Application Ser. No. 63/690,030, filed Sep. 3, 2024, and U.S. Provisional Application Ser. No. 63/760,740, filed Feb. 20, 2025, the disclosures all of which are hereby incorporated by reference in their entireties.

### FIELD OF THE INVENTION

The present invention relates to handrails, and in particular to handrails to be used adjacent doors to recreational vehicles.

### BACKGROUND OF THE INVENTION

Many recreational vehicles and vessels provide a series of steps and an associated hand bracket along their outer surfaces to accommodate easy access thereto.

Due to the mobility of the vehicle or the like, the hand bracket can be adjustably constructed to avoid interference with the desired travel. One common approach is to detachably secure the hand bracket to the vehicle so that it may be removed for travel. An example of such a construction is disclosed in U.S. Pat. No. 4,664,227 entitled PORTABLE BALUSTRADE AND PLATFORM ASSEMBLY. However, while such arrangements avoid travel interference, they involve labor-intensive and time-consuming operations to attach and detach, and therefore often become a nuisance to the user. Furthermore, suitable and easily-accessible storage space must be provided for receiving the hand bracket during travel. Also, the various fasteners utilized to assemble and attach the hand bracket must be kept track of to ensure that they will not become lost or erroneously used in the subsequent erection and attachment of the hand bracket. This problem is especially acute if the hand bracket is to be stored for a long duration before reassembling.

In an effort to alleviate these difficulties, past artisans have also developed collapsible hand brackets, such as disclosed in: U.S. Pat. No. 4,720,116 entitled STORABLE STAIRWAY AND PLATFORM APPARATUS FOR RECREATIONAL VEHICLES; U.S. Pat. No. 3,997,211 entitled RETRACTABLE PATIO ASSEMBLY FOR USE ON A PICKUP TRUCK MOUNTED CAMPER OR THE LIKE; and U.S. Pat. No. 3,912,298 entitled FOLDABLE STEPS FOR MOBILE HOME. However, these hand brackets typically involve a plurality of pivotally interconnected segments which cooperate to effect collapse of the hand bracket against the vehicle in a vertical plane or elements which fold against an enlarged horizontal porch section before collapsing against the side of the vehicle. These arrangements greatly increase the complexity of the hand bracket and invariably increase the cost of fabrication and the susceptibility to disrepair. Further examples of retractable handrails include those of U.S. Pat. No. 4,976,455 entitled HANDRAIL and U.S. Pat. No. 7,249,395 entitled HAND BRACKET.

Accordingly, an apparatus is desired having the aforementioned advantages and solving and/or making improvements on the aforementioned disadvantages.

### SUMMARY OF THE INVENTION

The present invention, according to one aspect, is directed to a retractable handrail comprising a rail assembly comprising a rail rod, an upper pivot assembly pivotally connected to an upper end of the rail rod, with the upper pivot assembly being configured to be connected to a support surface, a lower pivot assembly configured to be connected to the support surface, and a support shaft having a lower end pivotally connected to the lower pivot assembly, with the support shaft including a slider at an upper end of the support shaft. The slider is configured to slide within the rail assembly. Rotating the rail rod about the upper pivot assembly causes the slider to slide along the rail rod, thereby causing the support shaft to rotate about the lower pivot assembly. The slider is configured to be selectively fixed in a deployed location relative to the rail assembly such that the rail assembly and the support shaft are fixed in a deployed position. A lower end of the rail rod is configured to be spaced from the support surface in the deployed position to allow the rail assembly to be used as a handrest for people located adjacent to the retractable handrail. The slider is configured to be located at an upper location relative to the rail assembly to position the retractable handrail in a stowed position. The lower pivot assembly includes a fixed part configured to be connected to the support surface. The fixed part of the lower pivot assembly includes a pair of grip arms defining a receiving area therebetween, with the receiving area receiving the support shaft therein when the retractable handrail is in the stowed position. The pair of grip arms are configured to be resiliently moved away from each other to allow the support shaft to move into and out of the receiving area. The pair of grip arms maintain the support shaft in the receiving area when the retractable handrail is in the stowed position.

Another aspect of the present invention is to provide a retractable handrail comprising a rail assembly comprising a rail rod, an upper pivot assembly pivotally connected to an upper end of the rail rod, with the upper pivot assembly being configured to be connected to a support surface, a lower pivot assembly configured to be connected to the support surface, and a support shaft having a lower end pivotally connected to the lower pivot assembly, with the support shaft including a slider at an upper end of the support shaft. The slider is configured to slide within the rail assembly. Rotating the rail rod about the upper pivot assembly causes the slider to slide along the rail rod, thereby causing the support shaft to rotate about the lower pivot assembly. The slider is configured to be selectively fixed in a deployed location relative to the rail assembly such that the rail assembly and the support shaft are fixed in a deployed position. A lower end of the rail rod is configured to be spaced from the support surface in the deployed position to allow the rail assembly to be used as a handrest for people located adjacent to the retractable handrail. The slider is configured to be located at an upper location relative to the rail assembly to position the retractable handrail in a stowed position. The lower pivot assembly includes a fixed part configured to be connected to the support surface and a movable part connected to the support shaft, with the fixed part being pivotally connected to the movable part. The movable part and the fixed part of the lower pivot assembly include a plurality of interlocking connection blocks, with at least one of the movable part and the fixed part having at least two of the plurality of interlocking connection blocks. A pivot pin extends through the plurality of interlocking connection blocks to allow the movable part to rotate relative to the fixed part about an axis of rotation. The movable part of the lower pivot assembly is stepped such that a central longitudinal center line of the support shaft does not pass through the pivot pin.

Yet another aspect of the present invention is to provide a retractable handrail comprising a rail assembly comprising a rail rod, an upper pivot assembly pivotally connected to an upper end of the rail rod, with the upper pivot assembly being configured to be connected to a support surface, a lower pivot assembly configured to be connected to the support surface, and a support shaft having a lower end pivotally connected to the lower pivot assembly, with the support shaft including a slider at an upper end of the support shaft. The slider is configured to slide within the rail assembly. Rotating the rail rod about the upper pivot assembly causes the slider to slide along the rail rod, thereby causing the support shaft to rotate about the lower pivot assembly. The slider is configured to be selectively fixed in a deployed location relative to the rail assembly such that the rail assembly and the support shaft are fixed in a deployed position. A lower end of the rail rod is configured to be spaced from the support surface in the deployed position to allow the rail assembly to be used as a handrest for people located adjacent to the retractable handrail. The slider is configured to be located at an upper location relative to the rail assembly to position the retractable handrail in a stowed position. The lower pivot assembly includes a fixed part configured to be connected to the support surface and a movable part connected to the support shaft, with the fixed part being pivotally connected to the movable part. The movable part and the fixed part of the lower pivot assembly includes a plurality of interlocking connection blocks with a pivot pin extending through the plurality of interlocking connection blocks to allow the movable part to rotate relative to the fixed part, with the movable part including one of the plurality of interlocking connection blocks and the fixed part having two of the plurality of interlocking connection blocks. The one of the plurality of interlocking connection blocks of the fixed part is located between the two of the plurality of interlocking connection blocks of the movable part.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1 is a side schematic view of an example vehicle having an embodiment of a retractable handle according to the present invention.

FIG. 2 is a top perspective view of an embodiment of the retractable handle according to the present invention in a deployed position.

FIG. 3 is a side view of an embodiment of the retractable handle according to the present invention in the deployed position.

FIG. 4 is a top perspective view of an embodiment of the retractable handle according to the present invention in a stowed position.

FIG. 5 is a side view of an embodiment of the retractable handle according to the present invention in the stowed position.

FIG. 6 is an exploded perspective view of an embodiment of the retractable handle according to the present invention.

FIG. 7 is an end view of a rod rail of a rail assembly of an embodiment of the retractable handle according to the present invention.

FIG. 8 is a bottom perspective view of a cap of the rail assembly of an embodiment of the retractable handle according to the present invention.

FIG. 9 is a top perspective view of the cap of the rail assembly of an embodiment of the retractable handle according to the present invention.

FIG. 10 is a perspective view of a slider of an embodiment of the retractable handle according to the present invention.

FIG. 11 is a side view of the slider of an embodiment of the retractable handle according to the present invention.

FIG. 12 is a bottom view of the slider of an embodiment of the retractable handle according to the present invention.

FIG. 13 is a cross-sectional view of the slider of an embodiment of the retractable handle according to the present invention taken along the line XIII-XIII of FIG. 11.

FIG. 14 is a cross-sectional view of the slider of an embodiment of the retractable handle according to the present invention taken along the line XIV-XIV of FIG. 11.

FIG. 15 is a side view of the slider, a support tube and a grip tube of a support tube assembly of an embodiment of the retractable handle according to the present invention.

FIG. 16 is an end view of the slider and the rod rail of the rail assembly of an embodiment of the retractable handle according to the present invention.

FIG. 17 is a top view of a lower pivot assembly of an embodiment of the retractable handle according to the present invention.

FIG. 18 is a perspective view of a movable part of the lower pivot assembly of an embodiment of the retractable handle according to the present invention.

FIG. 19 is a top view of the movable part of the lower pivot assembly of an embodiment of the retractable handle according to the present invention.

FIG. 20 is a first end view of the movable part of the lower pivot assembly of an embodiment of the retractable handle according to the present invention.

FIG. 21 is a second end view of the movable part of the lower pivot assembly of an embodiment of the retractable handle according to the present invention.

FIG. 22 is a bottom view of the movable part of the lower pivot assembly of an embodiment of the retractable handle according to the present invention.

FIG. 23 is a perspective view of a fixed part of the lower pivot assembly of an embodiment of the retractable handle according to the present invention.

FIG. 24 is a top view of the fixed part of the lower pivot assembly of an embodiment of the retractable handle according to the present invention.

FIG. 25 is a bottom view of the fixed part of the lower pivot assembly of an embodiment of the retractable handle according to the present invention.

FIG. 26 is a side view of a second embodiment of the retractable handle according to the present invention in the stowed position, with the second embodiment of the retractable handle having a second embodiment of the lower pivot assembly.

FIG. 27 is a top view of the second embodiment of the lower pivot assembly according to the present invention.

FIG. 28 is a perspective view of a movable part of the second embodiment of the lower pivot assembly according to the present invention.

FIG. 29 is a top view of the movable part of the second embodiment of the lower pivot assembly according to the present invention.

FIG. 30 is a first end view of the movable part of the second embodiment of the lower pivot assembly according to the present invention.

FIG. 31 is a bottom view of the movable part of the second embodiment of the lower pivot assembly according to the present invention.

FIG. 32 is a cross-sectional view of the movable part of the second embodiment of the lower pivot assembly according to the present invention taken along line XXXII-XXXII of FIG. 29.

FIG. 33 is a perspective view of a fixed part of the second embodiment of the lower pivot assembly according to the present invention.

FIG. 34 is a top view of the fixed part of the second embodiment of the lower pivot assembly according to the present invention.

FIG. 35 is an end view of the fixed part of the second embodiment of the lower pivot assembly according to the present invention.

FIG. 36 is a bottom view of the fixed part of the second embodiment of the lower pivot assembly according to the present invention.

FIG. 37 is a side perspective view of the first embodiment of the lower pivot assembly including a spacer according to the present invention.

FIG. 38 is a front view of the spacer according to the present invention.

FIG. 39 is a perspective view of a third embodiment of the retractable handle according to the present invention in a stowed position.

FIG. 40 is a perspective view of a fixed part of a lower pivot assembly of the third embodiment of the retractable handle according to the present invention.

FIG. 41 is a top view of the fixed part of the lower pivot assembly of the third embodiment of the retractable handle according to the present invention.

FIG. 42 is a bottom view of the fixed part of the lower pivot assembly of the third embodiment of the retractable handle according to the present invention.

FIG. 43 is an end view of the fixed part of the lower pivot assembly of the third embodiment of the retractable handle according to the present invention.

FIG. 44 is a first perspective view of a movable part of the lower pivot assembly of the third embodiment of the retractable handle according to the present invention.

FIG. 45 is a second perspective view of the movable part of the lower pivot assembly of the third embodiment of the retractable handle according to the present invention.

FIG. 46 is a top view of the movable part of the lower pivot assembly of the third embodiment of the retractable handle according to the present invention.

FIG. 47 is a bottom view of the movable part of the lower pivot assembly of the third embodiment of the retractable handle according to the present invention.

FIG. 48 is an end view of the movable part of the lower pivot assembly of the third embodiment of the retractable handle according to the present invention.

FIG. 49 is a partial front view of the third embodiment of the retractable handle according to the present invention in the stowed position.

The specific devices and processes illustrated in the attached drawings and described in the following specification are simply exemplary embodiments of the inventive concepts.

Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined herein. Hence, specific dimensions and other physical characteristics relating to the embodiments disclosed herein are not to be considered as limiting, unless expressly stated otherwise.

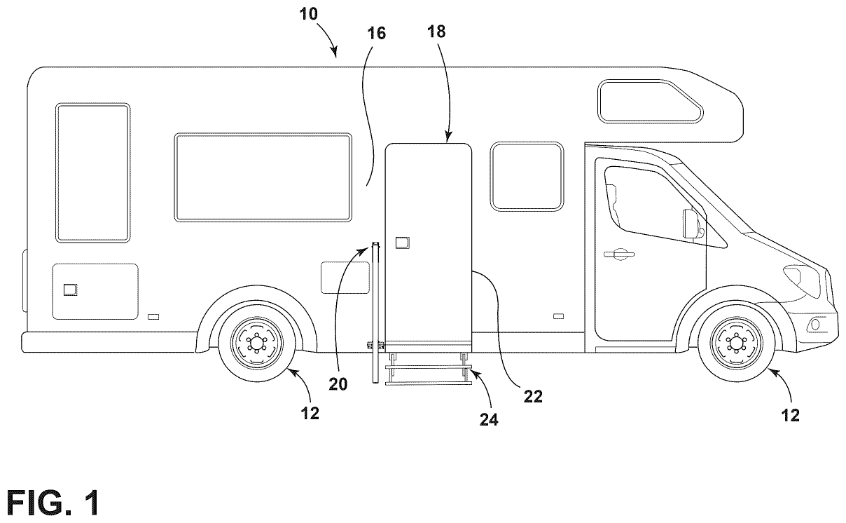

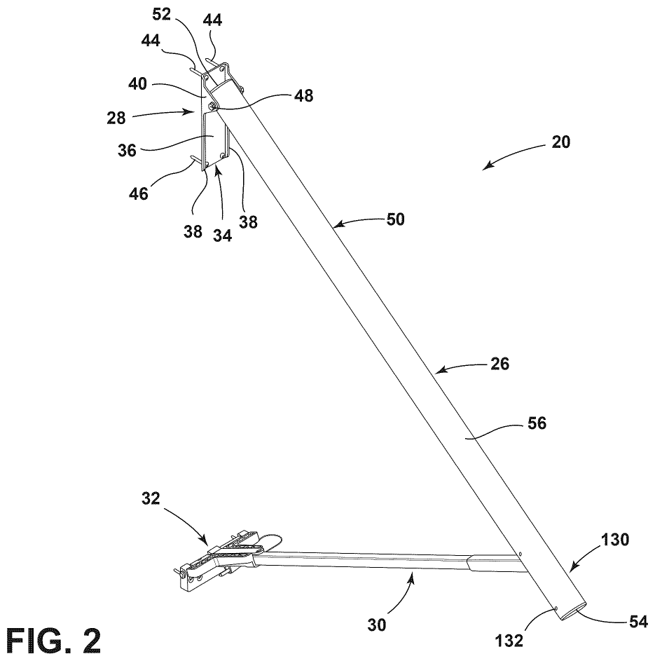

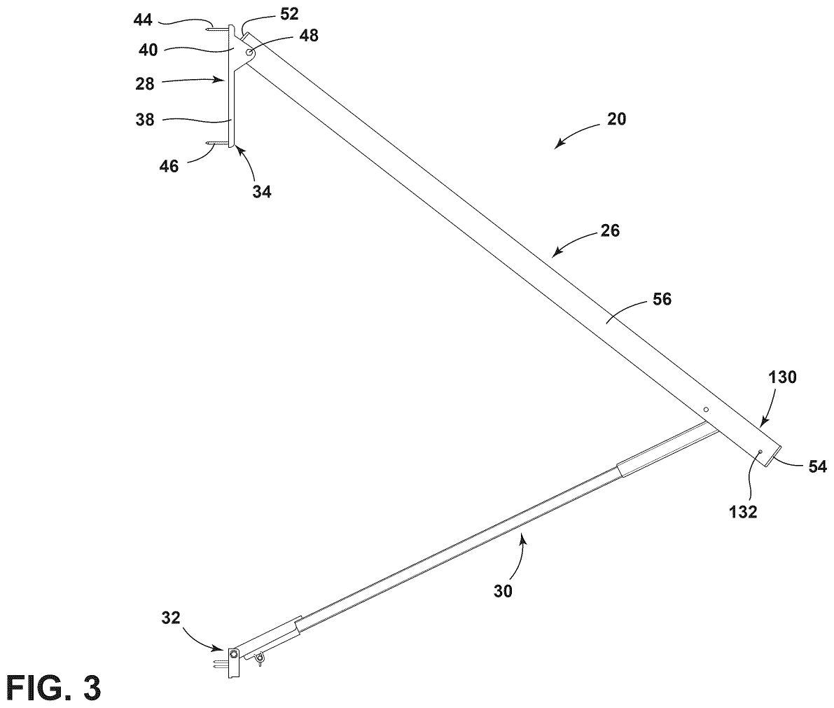

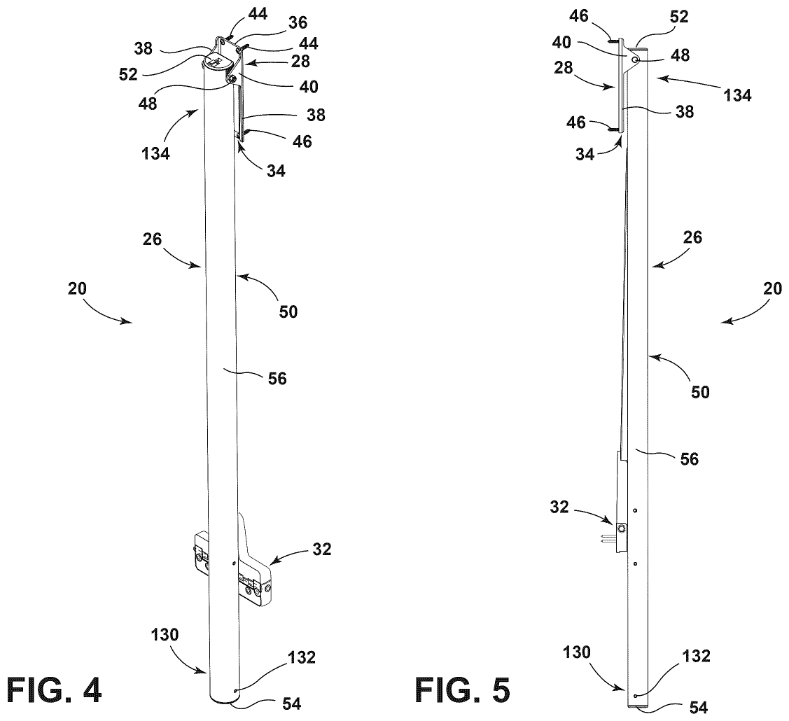

The reference number 10 (FIG. 1) generally designates a vehicle. The vehicle 10 is shown as a motor vehicle that includes living quarters designed for accommodation. Types of vehicles 10 include motorhomes, campervans, coaches, caravans (also known as travel trailers and camper trailers), fifth-wheel trailers, popup campers, and truck campers. This list is not exhaustive. Another example of a vehicle is a boat, a truck, a van, a car or any other type of personal conveyance. The example of the vehicle 10 as shown in FIG. 1 is a motorhome that is self-propelled via wheels 12 (with at least some of the wheels 12 being driven to move the motorhome). As shown in FIG. 1, the vehicle 10 (or any of the vehicles discussed herein) can include a retractable handle 20 on a wall 16 of the vehicle 10 adjacent to a door 18. The retractable handle 20 of the present embodiment is moved between a stowed position (see FIGS. 4 and 5) for travel and a deployed position (see FIGS. 2 and 3) for when the vehicle 10 is stationary (e.g., parked). The retractable handle 20, when in the deployed position, allows those passing through a doorway 22 and/or using steps 24 below the doorway 22 to stabilize themselves.

The illustrated retractable handle 20 is configured to be rotated relative to the wall 16 of the vehicle 10 to which it is affixed. The retractable handle 20 includes a rail assembly 26 rotatably attached to an upper pivot assembly 28 connected to the wall 16. While the upper pivot assembly 28 is illustrated as being connected to the wall 16, it is contemplated that the upper pivot assembly 28 could be integral with the wall 16. The rail assembly 26 is rotated away from the wall 16 when the retractable handle 20 is in the deployed position and is positioned adjacent the wall 16 when the retractable handle 20 is in the stowed position. The retractable handle 20 further includes a support tube assembly 30 for supporting a lower end of the rail assembly 26 opposite the upper pivot assembly 28 when the retractable handle 20 is in the deployed position. The support tube assembly 30 is pivotally attached to the wall 16 with a lower pivot assembly 32.

In the illustrated example, the upper pivot assembly 28 is connected to the wall 16 of the vehicle 10. The upper pivot assembly 28 (FIGS. 2-6) includes a substantially U-shaped pivot plate 34 having a base panel 36 and a pair of parallel side panels 38 extending outward from opposite sides of the base panel 36. Each of the side panels 38 includes an enlarged ear area 40 having an opening 42 therein. The upper pivot assembly 28 can be connected to the wall 16 by inserting upper fasteners 44 through an upper portion of the base panel 36 and into the wall 16 along with inserting lower fasteners 46 through a lower portion of the base panel 36 and into the wall 16. However, it is contemplated that the upper pivot assembly 28 can be connected to the wall 16 in any manner or integral with the wall. The rail assembly 26 is connected to the upper pivot assembly 28 by inserting a pivot pin 48 through the openings 42 in the enlarged ear areas 40 and through an upper portion of the rail assembly 26. It is contemplated that the substantially U-shaped pivot plate 34 can be formed of any rigid material (e.g., metal).

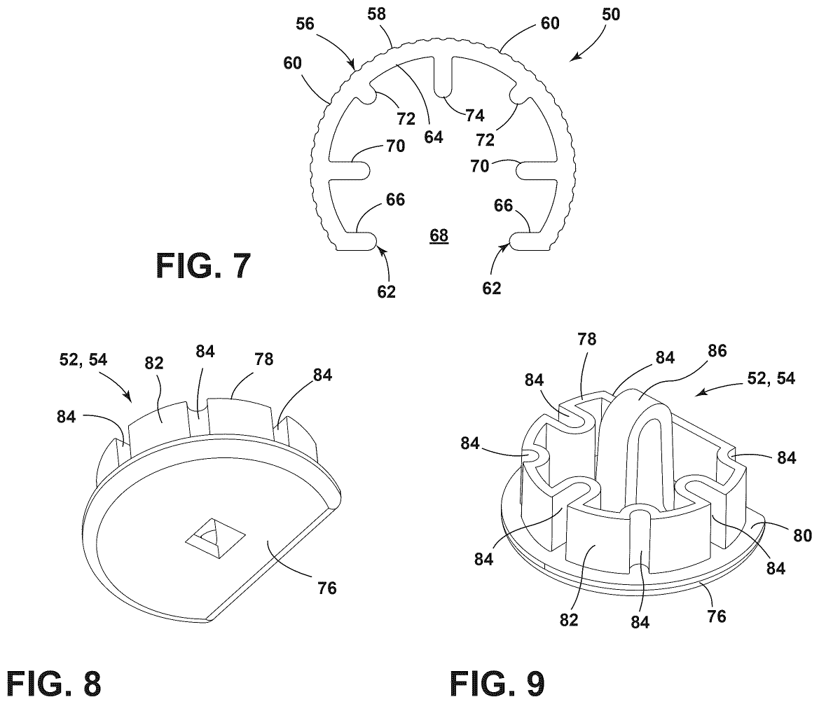

The illustrated rail assembly 26 pivots about the upper pivot assembly 28 between the stowed position and the deployed position. The rail assembly 26 (see FIGS. 2-7) includes a rail rod 50, an upper cap 52 and a lower cap 54. The upper cap 52 is inserted into an upper end of the rail rod 50 and the lower cap 54 is inserted into the lower end of the rail rod 50. The rail rod 50 includes a grip piece 56 in the shape of a major arc of a circle. The grip piece 56 has an outer surface 58 that is gripped during use. It is contemplated that the outer surface 58 would be smooth or could have a contour to assist in gripping the grip piece 56. For example, the outer surface 58 could include a plurality of parallel longitudinal grooves 60 as shown in FIG. 7 or any other surface treatment (e.g., a roughed surface). A plurality of flanges 62 extend inward from an inside surface 64 of the grip piece 56. The flanges 62 include a pair of bottom parallel flanges 66 extending toward each other at an open mouth 68 of the grip piece 56, a pair of upper parallel flanges 70 extending toward each other above the pair of bottom parallel flanges 66, a pair of angled alignment flanges 72 located above the pair of upper parallel flanges 70, and a downwardly extending flange 74 located at substantially the midpoint of the arc. The rail rod 50 can be formed from any material and in any manner (e.g., extruded metal or plastic). Likewise, the upper cap 52 and the lower cap 54 can be formed from any material and in any manner (e.g., injection molded metal or plastic).

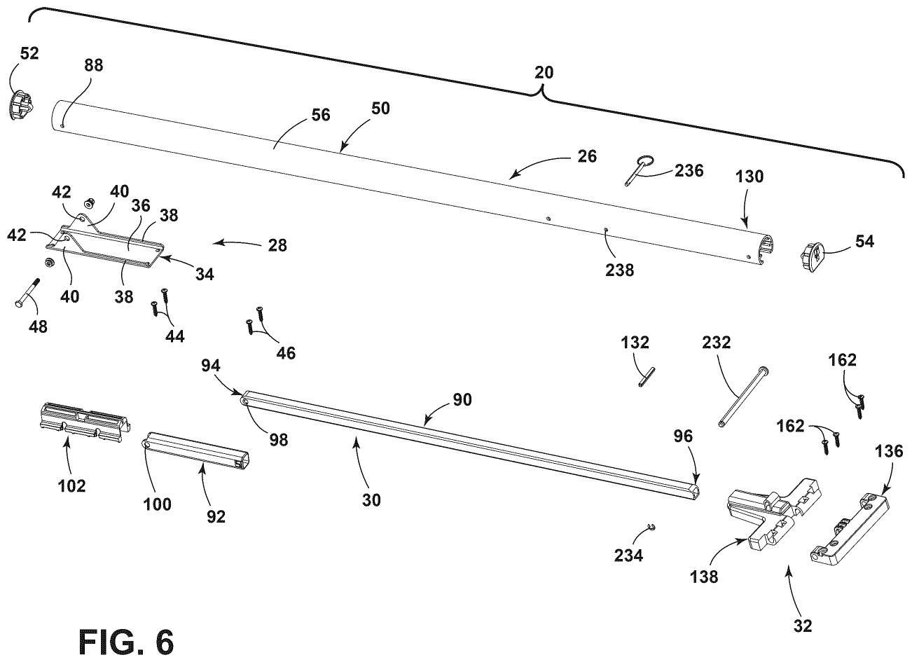

In the illustrated example, the grip piece 56 of the rail rod 50 includes a pair of aligned holes 88 adjacent a top end thereof as shown in FIG. 6. The pivot pin 48 extends through the openings 42 in the enlarged ear areas 40 of the side panels 38 of the U-shaped pivot plate 34 and through the holes 88 to connect the rail assembly 26 to the upper pivot assembly 28 and to allow the rail assembly 26 to pivot between the stored and deployed position as outlined above.

The illustrated upper cap 52 and the lower cap 54 (see FIGS. 8-9) enclose upper and lower ends of the rail rod 50. The upper cap 52 and the lower cap 54 can be identical (as illustrated) or can have different configurations. Since the illustrated upper cap 52 is identical to the lower cap 54, only the upper cap 52 will be described with the understanding that the lower cap 54 has the same features. The upper cap 52 includes an end plate 76 having a ridge 78 extending from a surface 80 of the end plate 76. A periphery 82 of the ridge 78 has substantially the same shape as the inside surface 64 of the grip piece 56 of the rail rod 50, with the ridge 78 including a plurality of channels 84 corresponding to the shape of the flanges 62. A U-shaped projection 86 extends through an interior of the ridge 78 from the surface 80 to add strength to the upper cap 52 and to act as a stop as outlined in more detail below. The upper cap 52 is inserted into the upper end of the rail rod 50 and fits within the rail rod 50 in an interference fit and the lower cap 54 is inserted into the lower end of the rail rod 50 and fits within the rail rod 50 in an interference fit as shown in FIGS. 2-5.

In the illustrated example, the rail assembly 26 moves between the stored and deployed position as outlined above and is supported by the support tube assembly 30 when in the deployed position. The support tube assembly 30 (see FIGS. 2-6) includes a support tube 90 and a grip tube 92. As shown in FIG. 6, the support tube 90 is elongated and has a top end 94 and a bottom end 96. The support tube 90 can be formed from any material and in any manner (e.g., extruded metal or plastic). The top end 94 is inserted into the grip tube 92 and the bottom end 96 is inserted into the lower pivot assembly 32. The support tube 90 can have any cross-sectional shape (e.g., square as shown) as long as the receptacles for the grip tube 92 and the lower pivot assembly 32 have the same shape. The top end 94 of the support tube 90 has an aperture 98 therethrough. The grip tube 92 is tubular and formed of a material that makes the upper end of the rail assembly 26 easy to grasp and move (e.g., plastic or rubber). The grip tube 92 includes a pair of holes 100 at an end thereof that are configured to align with the aperture in the support tube 90 after the grip tube 92 is inserted over the top end 94 of the grip tube 92.

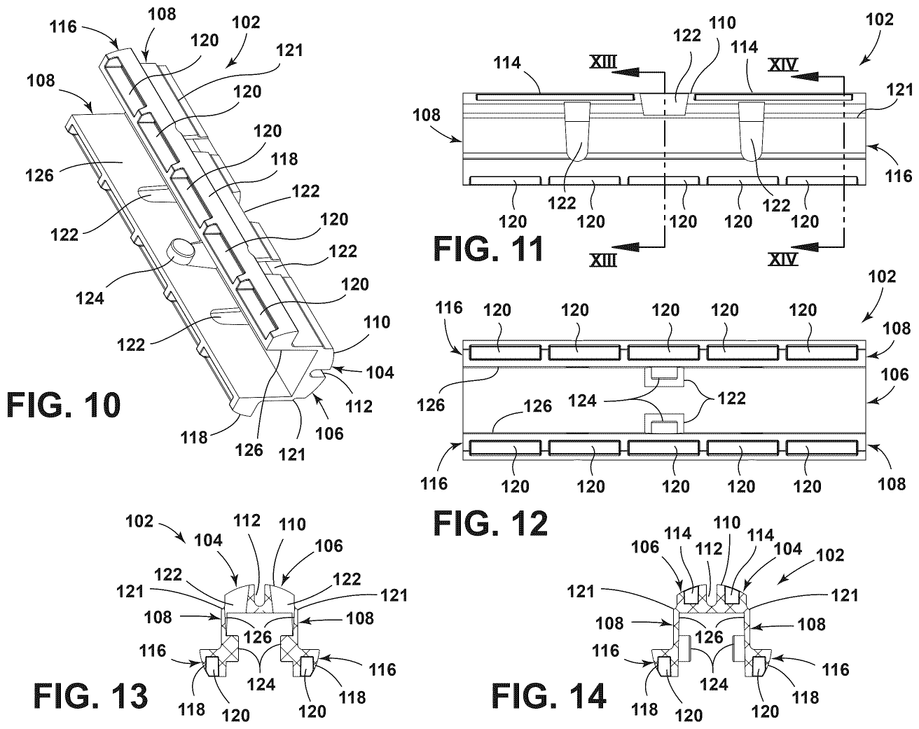

The illustrated support tube assembly 30 further includes a slider 102 (see FIGS. 10-16) connected to the top end 94 of the support tube 90 to connect the support tube assembly 30 to the rail assembly 26. The slider 102 has a substantially inverted U-shaped body 104 with a top panel 106 and a pair of side panels 108 connected to opposite longitudinal edges of the top panel 106. The top panel 106 has a curved top surface 110 with a longitudinal groove 112 extending the entire length of the top surface 110 parallel to the side panels 108. The top panel 106 further includes a plurality of upwardly facing channels 114 substantially parallel to the longitudinal groove 112. It is contemplated that any number of upwardly facing channels 114 could be used (e.g., four total, with two on each side of the longitudinal groove 112 as shown). Each of the side panels 108 includes a support flange 116 extending outwardly therefrom at an end thereof opposite the end of the side panels 108 connected to the top panel 106. The support flanges 116 have an outer curved face 118 and downwardly facing recesses 120. The support flanges 116 can include any number of downwardly facing recesses 120 (e.g., five similar shaped downwardly facing recesses 120 for each support flange 116 as shown). A top of the side panels 108 can include a longitudinal ledge 121 as shown in FIGS. 10, 13 and 14. It is further contemplated that the slider 102 can include a plurality of cut-out portions 122 either through the top portion of the side panels 108 (e.g., two for each side as shown in FIGS. 10 and 11), through the top panel 106 (e.g., one centrally located on each side as shown in FIG. 10), or through both the side panels 108 and the top panel 106 (not shown).

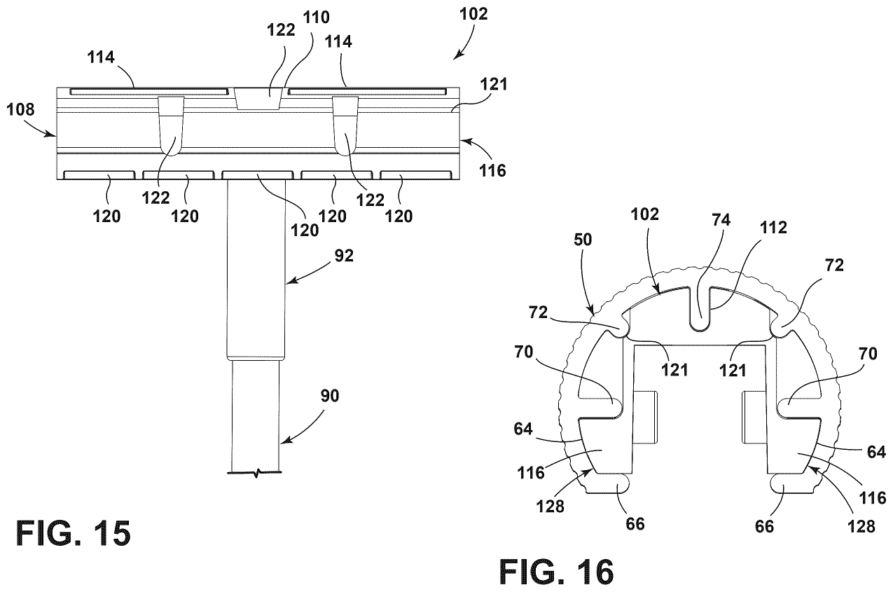

The illustrated slider 102 is connected to the support tube 90 and the grip tube 92. As shown in FIGS. 12-14, the slider 102 includes a pair of discs 124 that extend toward each other from inside surfaces 126 of the side panels 108. In the illustrated example, the discs 124 are located directly below the centrally located cut-out portions 122 through the top panel 106. The slider 102 is connected to the support tube 90 and the grip tube 92 by inserting the discs 124 into the holes 100 of the grip tube 92 and the apertures 98 of the support tube 90. Therefore, the slider 102 is configured to rotate about the holes 100 and the apertures 98 to rotate relative to an end of the support tube 90 and the grip tube 92. FIG. 15 illustrates the support tube 90 and the grip tube 92 rotated to a position above and perpendicular to a longitudinal direction of the slider 102, but the support tube 90 and the grip tube 92 are configured to be rotated up to about parallel to the longitudinal direction of the slider 102. The slider 102 can be formed from any material and in any manner (e.g., injection molded metal or plastic).

In the illustrated example, the slider 102 is configured to slide within the rail rod 50 of the rail assembly 26 to move the retractable handle 20 between the stowed position and the deployed position. As shown in FIG. 16, the slider 102 fits securely within the rail rod 50. Specifically, each support flange 116 on the side panels 108 is positioned in a space 128 bounded by the inside surface 64, the upper parallel flange 70 and the lower parallel flange 66 of the rail rod 50. Moreover, as shown in FIG. 16, the angled alignment flange 72 of the rail rod 50 abuts the longitudinal ledge 121 of the slider 102 and the downwardly extending flange 74 of the rail rod 50 extends into the groove 112 in the top surface 110 of the top panel 106 of the U-shaped body 104 of the slider 102. In the deployed position as shown in FIGS. 2 and 3, the slider 102 is located adjacent a bottom end 130 of the rail rod 50 and prevented from sliding any further by a stop pin 132 extending through the rail rod 50. In the stowed position as shown in FIGS. 4 and 5, the slider 102 is located adjacent a top end 134 of the rail rod 50.

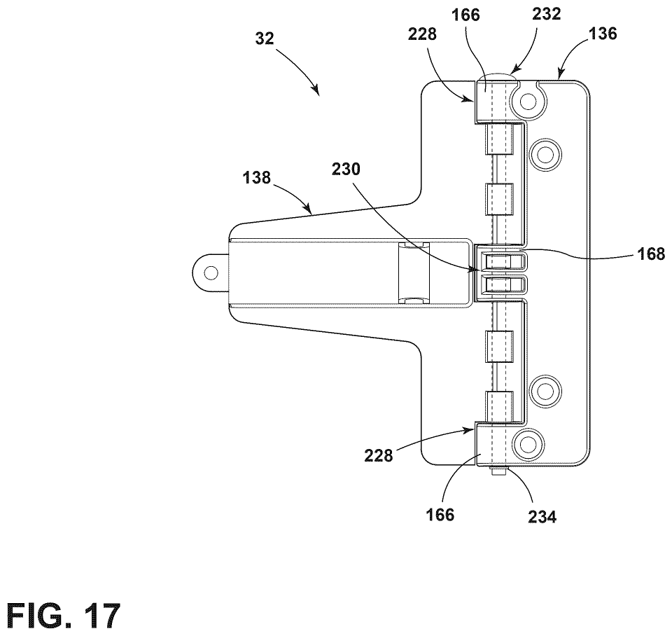

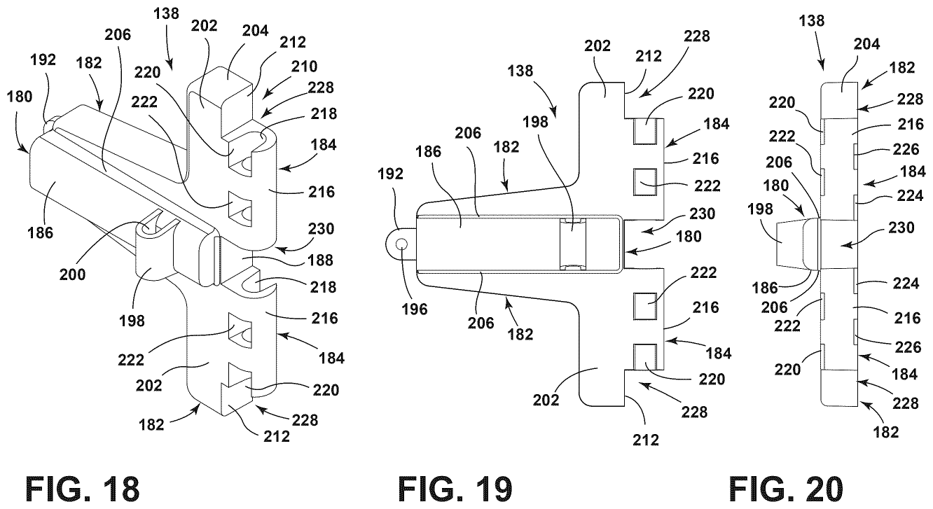

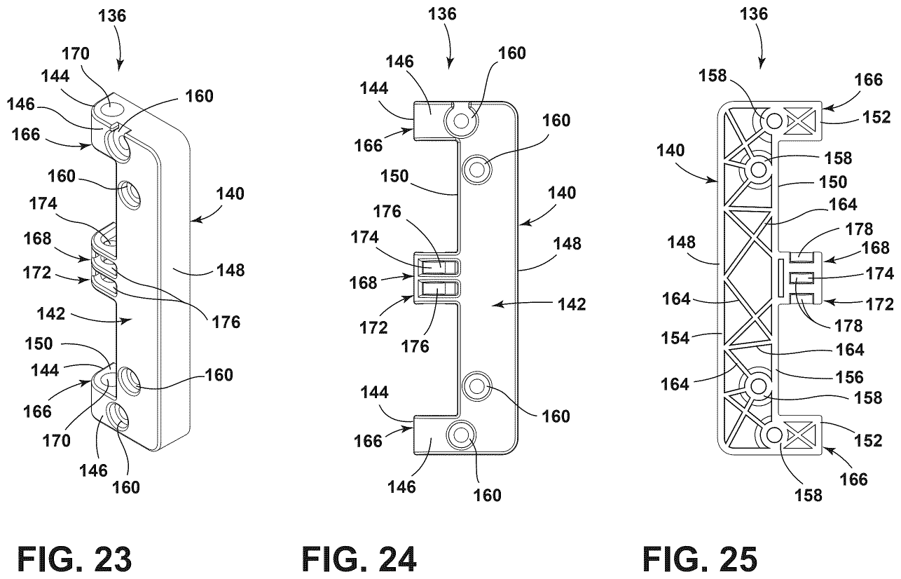

The illustrated lower pivot assembly 32 (FIGS. 17-25) pivotally attaches the support tube assembly 30 to the wall 16 and allows the support tube assembly 30 to move between the deployed position as shown in FIGS. 2 and 3 and the stowed position as shown in FIGS. 4 and 5. The lower pivot assembly 32 includes a fixed part 136 (see FIGS. 23-25) connected to the wall 16 and a movable part 138 (see FIGS. 18-22) connected to the support tube assembly 30. The movable part 138 is rotatably connected to the fixed part 136. The fixed part 136 and the movable part 138 can be formed from any material and in any manner (e.g., injection molded metal or plastic).

In the illustrated example, the fixed part 136 of the lower pivot assembly 32 is connected to the wall 16. The fixed part 136 comprises a substantially W-shaped body 140 as shown in FIG. 24. The body 140 includes a U-shaped front plate 142 having curved ends 144 at the ends of opposite arms 146 of the U-shaped front plate 142. An outer U-shaped peripheral rim 148 extends downwardly from an outer peripheral edge of the U-shaped front plate 142 and an inner U-shaped peripheral rim 150 extends downwardly from an inner peripheral edge of the U-shaped front plate 142.

As shown in FIG. 25, bottom free edges 152 of the curved ends 144, a bottom free edge 154 of the outer U-shaped peripheral rim 148 and a bottom free edge 156 of the inner U-shaped peripheral rim 150 are level for placement against the wall 16. A plurality of fastener cylinders 158 extend downwardly from counterbores 160 in the U-shaped front plate 142. Fasteners 162 (see FIG. 6) extend through the fastener cylinders 158 and into the wall 16 to connect the fixed part 136 to the wall 16, with heads of the fasteners 162 being positioned in the counterbores 160. The fixed part 136 further includes a plurality of struts 164 extending between the outer U-shaped peripheral rim 148, the inner U-shaped peripheral rim 150 and the fastener cylinders 158 to provide stability to the fixed part 136.

The illustrated fixed part 136 is connected to the movable part 138. The fixed part 136 includes a pair of outside pivot areas 166 and a central pivot area 168. Each outside pivot area 166 includes a hole 170 that extends through the outer U-shaped peripheral rim 148, the inner U-shaped peripheral rim 150 and any struts 164 located therebetween. The central pivot area 168 comprises a block 172 connected to a central area of the inner U-shaped peripheral rim 150. The block 172 includes an aperture 174 aligned with the holes 170 in the outside pivot areas 166. As shown in FIGS. 23-25, the block 172 can include a pair of upper cut outs 176 above the aperture 174 and lower cut outs 178 below the aperture 174 that are not aligned with the upper cut outs 176.

In the illustrated example, the movable part 138 of the lower pivot assembly 32 is connected to the support tube 90 of the support tube assembly 30 and to the fixed part 136 of the lower pivot assembly 32. The movable part 138 includes a tube receiver portion 180, a pair of L-shaped wing portions 182 and a pair of connection block portions 184. The tube receiver portion 180 receives the support tube 90 of the support tube assembly 30, the pair of connection block portions 184 are connected to the fixed part 136, and the pair of L-shaped wing portions 182 are located between the tube receiver portion 180 and the pair of connection block portions 184.

The illustrated tube receiver portion 180 of the movable part 138 connects the movable part 138 to the support tube 90 of the support tube assembly 30. The tube receiver portion 180 includes a tubular section 186 having a closed bottom 188. An interior periphery 190 of the tubular section 186 can conform to the exterior shape of the support tube 90. The tubular section 186 can receive the bottom end 96 of the support tube 90 therein until the support tube 90 abuts the closed bottom 188. The tube receiver portion 180 includes a connection tab 192 extending from the tubular section 186 adjacent an open mouth 194 of the tubular section 186. Once the support tube 90 is fully inserted into the tubular section 186, a fastener can be inserted through an aperture 196 of the connection tab 192 and into the support tube 90 to lock the support tube 90 into the tube receiver portion 180 of the movable part 138. The tube receiver portion 180 can also include a lock sleeve 198 extending outwardly from a side of the tubular section 186. As discussed in more detail below, a pin can be positioned through an opening 200 in the lock sleeve 198 to lock the retractable handle 20 in the stowed position.

In the illustrated example, the pair of L-shaped wing portions 182 connect the tube receiver portion 180 to the pair of connection block portions 184. Each of the pair of L-shaped wing portions 182 include an L-shaped top plate 202 connected to a side face 206 of the tubular section 186 of the tube receiver portion 180. A peripheral rim 204 extends downwardly from a periphery edge of the L-shaped top plate 202 and extends to a level even with a bottom face 208 of the tubular section 186. Each connection block portion 184 is located at an interrupted bottom area 210 of the peripheral rim 204, with the interrupted bottom area 210 having a pair of outside sections 212 and the bottom 188 of the tube receiver portion 180. As shown in FIG. 22, a plurality of struts 214 can extend rearwardly from the L-shaped top plate 202 between the tubular section 186, the peripheral rim 204 and the connection block portions 184.

The illustrated connection block portions 184 of the movable part 138 rotatably connect to the movable part 138 to the fixed part 136. Each of the connection block portions 184 extend from the L-shaped wing portions 182 between one of the outside sections 212 and the bottom of the tube receiver portion 180 of the interrupted bottom area 210. Each connection block portion 184 has an arched surface 216 facing away from the L-shaped wing portions 182 and an opening 218 therethrough. The arched surface 216 can include a first open upper cut out 220 that extends to the opening 218 adjacent an outside of the connection block portions 184 and open to the outside. The arched surface 216 can also include a second closed upper cut out 222 that extends to the opening 218 located between the first open upper cut out 220 and the bottom 188 of the tube receiver portion 180. Moreover, the arched surface 216 can include a first open lower cut out 224 that extends to the opening 218 and open to an area between the connection block portions 184. Furthermore, the arched surface 216 can also include a second closed lower cut out 226 that extends to the opening 218 located between the first open lower cut out 224 and the outside sections 212.

In the illustrated example, the fixed part 136 is rotatably connected to the movable part 138. The movable part 138 includes a pair of outer receiving areas 228 located outside of the connection block portions 184 and a central receiving area 230 located between the connection block portions 184. As illustrated in FIG. 17, the central pivot area 168 of the fixed part 136 is located in the central receiving area 230 of the movable part 138 and the outside pivot areas 166 of the fixed part 136 are each located in one of the outer receiving areas 228 of the movable part 138. A pivot pin 232 is inserted through the hole 170 in the outside pivot areas 166 of the fixed part 136, the openings 218 in each of the connection block portions 184 of the movable part 138 and the aperture 174 in the block 172 of the fixed part 136. A catch 234 can be connected to an end of the pivot pin 232 to maintain the pivot pin 232 in position.

The illustrated retractable handle 20 can be placed in the stowed position as shown in FIGS. 4 and 5 to position the retractable handle 20 adjacent the wall 16. For example, the retractable handle 20 can be placed in the stowed position while the vehicle 10 is moving. It is contemplated that the retractable handle 20 can be locked in the stowed position in any manner. For example, the lock sleeve 198 can be positioned within the open mouth 68 of the grip piece 56 of the rail rod 50 adjacent a lock hole 238 (see FIGS. 5 and 6). A lock pin 236 (see FIG. 6) can be inserted through the lock hole 238 and through the opening 200 in the lock sleeve 198 to prevent the rail rod 50 from moving away from the wall 16.

In the illustrated example, the retractable handle 20 can be moved from the stowed position to the deployed position. To move the retractable handle 20 from the stowed position to the deployed position, the rail assembly 26 is rotated about the upper pivot assembly 28 to a position as shown in FIGS. 2 and 3. While the rail assembly 26 is rotated about the upper pivot assembly 28, the slider 102 will slide down the rail rod 50 as the movable part 138 of the lower pivot assembly 32 rotates relative to the fixed part 136 of the lower pivot assembly 32. The slider 102 moves until the slider 102 abuts the stop pin 132 as outlined above. When the slider 102 abuts the stop pin 132, the retractable handle 20 is in the deployed position. It is contemplated that the lock pin 236 can be inserted through the lock hole 238 to prevent the slider 102 from moving upward in the rail rod 50. To move the retractable handle 20 back to the stowed position, the slider 102 is moved up the rail rod 50 while the rail rod 50 is rotated downward.

FIG. 26 illustrates a second embodiment of the retractable handle 20a. The second embodiment of the retractable handle 20a includes a second embodiment of the lower pivot assembly 32a, but the remaining elements of the second embodiment of the retractable handle 20a can be identical to the elements of the first embodiment of the retractable handle 20 as illustrated in FIGS. 1-19. Therefore, the second embodiment of the retractable handle 20a can include the rail assembly 26, the upper pivot assembly 28 and the support tube assembly 30 of the first embodiment of the retractable handle 20 as illustrated in FIGS. 1-19.

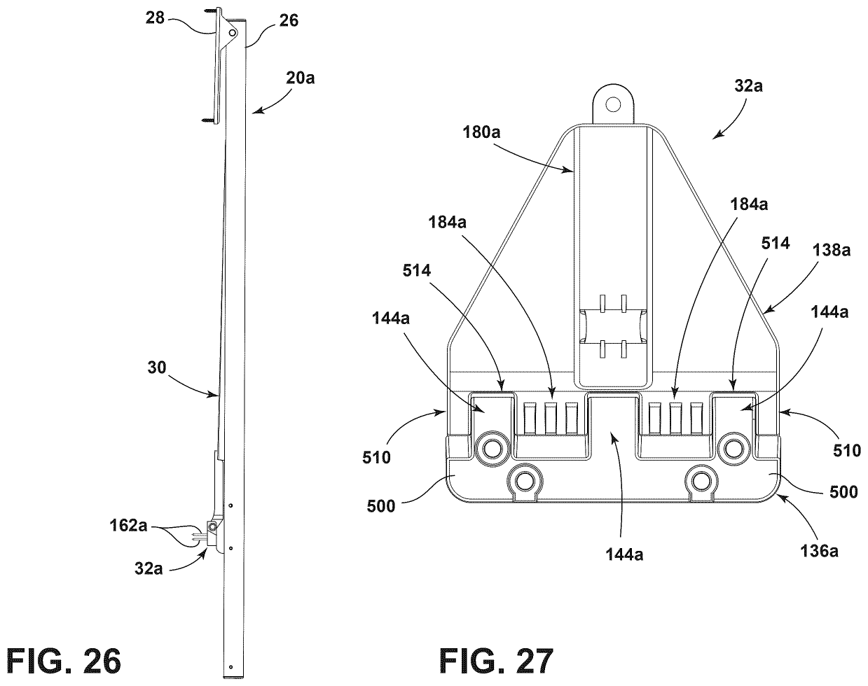

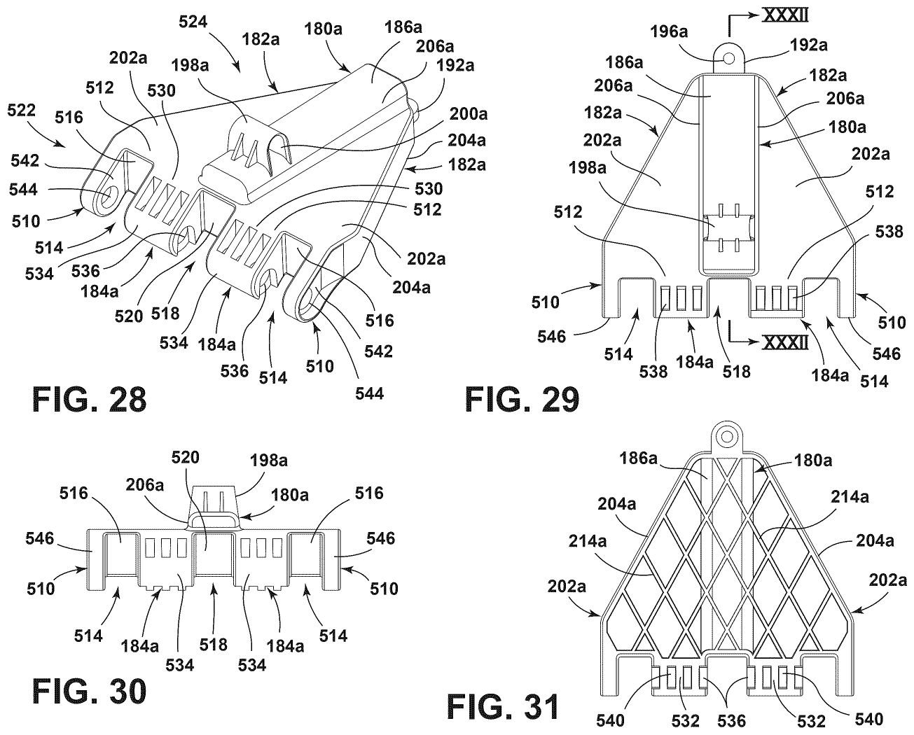

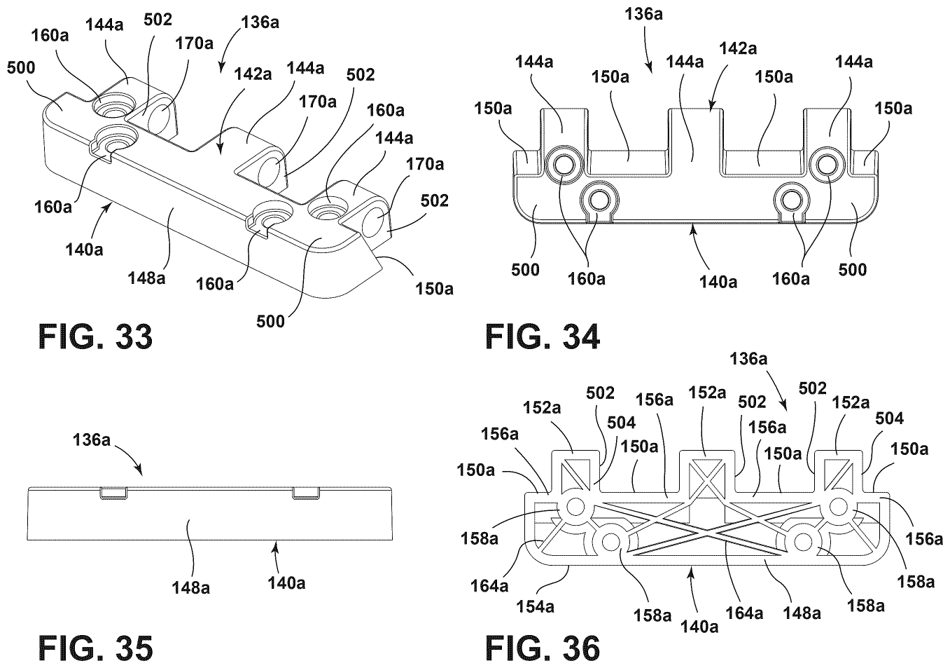

The illustrated second embodiment of the lower pivot assembly 32a (FIGS. 27-36) includes a fixed part 136a (see FIGS. 33-36) connected to the wall 16 and a movable part 138a (see FIGS. 28-32) connected to the support tube assembly 30. The movable part 138a is rotatably connected to the fixed part 136a. The fixed part 136a and the movable part 138a can be formed from any material and in any manner (e.g., injection molded metal or plastic).

In the illustrated example, the fixed part 136a of the lower pivot assembly 32a is connected to the wall 16. The fixed part 136a comprises a substantially W-shaped body 140a as shown in FIG. 34. The body 140a includes a W-shaped front plate 142a that includes three curved fingers 144a adjacent but spaced from opposite ends of the W-shaped front plate 142a and in a middle of the W-shaped front plate 142a to form the W-shape of the W-shaped front plate 142a. The W-shaped front plate 142a also includes a pair of lateral extensions 500 that extend outward.

An outer U-shaped peripheral rim 148a extends downwardly from an outer peripheral edge of the W-shaped front plate 142a. An interrupted inner peripheral rim 150a extends downwardly from an inner peripheral edge of the W-shaped front plate 142a between the outside three curved fingers 144a and outside of the outer curved fingers 144a, with the interrupted inner peripheral rim 150a being slanted away from the outer U-shaped peripheral rim 148a. Side rims 502 extend downwardly from each side of the curved fingers 144a.

As shown in FIG. 36, bottom free edges 152a of the curved fingers 144a, a bottom free edge 154a of the outer U-shaped peripheral rim 148a, a bottom free edge 156a of the interrupted inner peripheral rim 150a and bottom free edges 504 of the side rims 502 are level for placement against the wall 16. A plurality of fastener cylinders 158a extend downwardly from counterbores 160a in the W-shaped front plate 142a. Fasteners 162a (see FIG. 26) extend through the fastener cylinders 158a and into the wall 16 to connect the fixed part 136a to the wall 16, with heads of the fasteners 162a being positioned in the counterbores 160a. The fixed part 136a further includes a plurality of struts 164a extending between the outer U-shaped peripheral rim 148a, the interrupted inner peripheral rim 150a, the fastener cylinders 158a and the bottom free edges 504 to provide stability to the fixed part 136a.

The illustrated fixed part 136a is connected to the movable part 138a. The three curved fingers 144a define a pair of outside pivot areas and a central pivot area. Each outside pivot area and the central pivot area includes aligned holes 170a that extend through the side rims 502.

In the illustrated example, the movable part 138a of the lower pivot assembly 32a is connected to the support tube 90 of the support tube assembly 30 and to the fixed part 136a of the lower pivot assembly 32a. The movable part 138a includes a tube receiver portion 180a, a pair of triangular wing portions 182a, a pair of connection block portions 184a and a pair of outer connection portions 510. The tube receiver portion 180a receives the support tube 90 of the support tube assembly 30, the pair of connection block portions 184a and the pair of outer connection portions 510 are connected to the fixed part 136a, and the pair of triangular wing portions 182a are located between the tube receiver portion 180a and both the pair of connection block portions 184a and the pair of outer connection portions 510.

The illustrated tube receiver portion 180a of the movable part 138a connects the movable part 138a to the support tube 90 of the support tube assembly 30. The tube receiver portion 180a includes a tubular section 186a having a closed bottom 188a. An interior periphery 190a of the tubular section 186a can conform to the exterior shape of the support tube 90. The tubular section 186a can receive the bottom end 96 of the support tube 90 therein until the support tube 90 abuts the closed bottom 188a. The tube receiver portion 180a includes a connection tab 192a extending from the tubular section 186a adjacent an open mouth 194a of the tubular section 186a. Once the support tube 90 is fully inserted into the tubular section 186a, a fastener can be inserted through an aperture 196a of the connection tab 192a and into the support tube 90 to lock the support tube 90 into the tube receiver portion 180a of the movable part 138a. The tube receiver portion 180a can also include a lock sleeve 198a extending outwardly from a side of the tubular section 186a. As discussed above, a pin can be positioned through an opening 200a in the lock sleeve 198a to lock the retractable handle 20a in the stowed position.

In the illustrated example, the pair of triangular wing portions 182a connect the tube receiver portion 180a to the pair of connection block portions 184a. Each of the pair of triangular wing portions 182a include a triangular top plate 202a connected to a side face 206a of the tubular section 186a of the tube receiver portion 180a. A peripheral rim 204a extends downwardly from a periphery edge of each outside edge of the triangular top plate 202a. One of the connection block portions 184a and one of the outer connection portions 510 extend outward and downward from a lower edge 512 of each of the triangular wing portions 182a. Outer receiver areas 514 are located between each of the connection block portions 184a and the outer connection portions 510. An outer vertical wall 516 extends between each of the connection block portions 184a and the outer connection portions 510 as shown in FIGS. 28 and 30. An inner receiver area 518 is located between the connection block portions 184a. An inner vertical wall 520 extends between the connection block portions 184a as shown in FIGS. 28 and 30. As shown in FIG. 31, a plurality of struts 214a can extend rearwardly from the triangular top plate 202a.

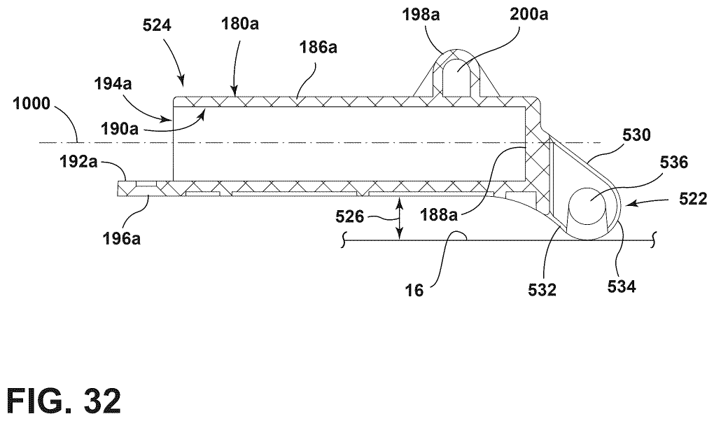

The illustrated movable part 138a includes a stepped configuration for mounting over trim or other projections connected to the wall 16 of the vehicle 10 as shown in FIG. 32. The movable part 138a therefore includes a lower portion 522 that connects to the fixed part 136a, which is flush with the wall 16. The movable part 138a also includes a raised portion 524 that is configured to be spaced from the wall 16 (or at least a part of the wall 16) that is parallel with the part of the wall 16 connected to the fixed part 136. The raised portion 524 of the movable part 138a includes the tube receiver portion 180a, the triangular wing portions 182a, the outer vertical walls 516, the inner vertical wall 520 and the struts 214a extending between these portions. The lower portion 522 includes the pair of connection block portions 184a and the pair of outer connection portions 510. As shown in FIGS. 28 and 30, the pair of connection block portions 184a and the pair of outer connection portions 510 are angled away from the raised portion 524 to create a clearance distance 526. The clearance distance 526 spaces the raised portion 524 away from the wall 16 or over any trim (or anything else) on the wall 16. Therefore, the movable part 138a of the lower pivot assembly 32a is stepped such that a central longitudinal center line 1000 of the support tube assembly 30 and the tube receiver portion 180a does not pass through the pivot pin as shown in FIG. 32.

In the illustrated example, the connection block portions 184a are angled away from the raised portion 524 to create the clearance distance 526. Each connection block portion 184a includes an upper angled surface 530, a lower angled surface 532 and an arcuate surface 534 therebetween. An opening 536 extends through each connection block portion 184a. Upper cut outs 538 can be positioned in the upper angled surface 530 and extend into the opening 536. Likewise, lower cut outs 540 can be positioned in the lower angled surface 532 and extend into the opening 536.

The illustrated outer connection portions 510 are also angled away from the raised portion 524 to create the clearance distance 526. Each outer connection portion 510 includes an angled plate 542 having an opening 544 therein that is parallel with the openings 536 in the connection block portions 184a. Each outer connection portion 510 also includes a peripheral rim 546 on a perimeter of the angled plate 542.

In the illustrated example, the fixed part 136a is rotatably connected to the movable part 138a. As illustrated in FIG. 27, a central one of the curved fingers 144a of the fixed part 136a is located between the connection block portions 184a in the inner receiver area 518. Moreover, the outer curved fingers 144a of the fixed part 136a are located between one of the connection block portions 184a and one of the outer connection portions 510 in the outer receiver areas 514. Moreover, the outer connection portions 510 are adjacent to the lateral extensions 500. A pivot pin is inserted through the openings 536, the openings 544, and the holes 170 to rotatably connect the movable part 138a to the fixed part 136a in the same manner as the pivot pin 232 rotatably connects the movable part 138 to the fixed part 136 of the first embodiment of the lower pivot assembly 32.

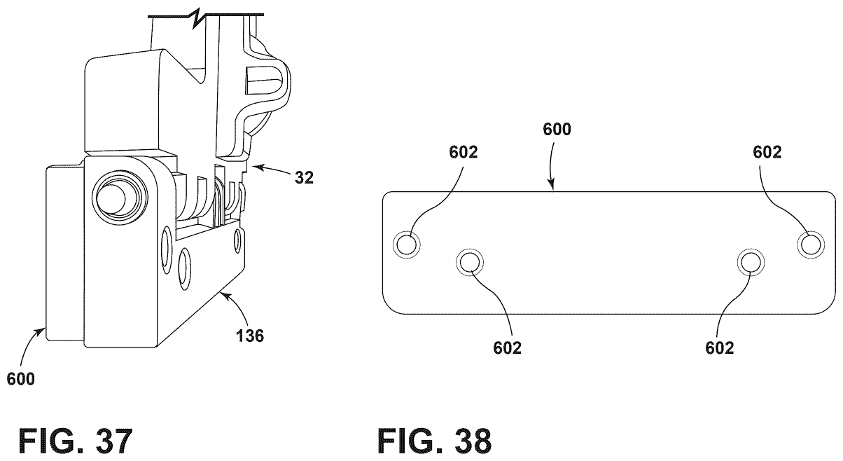

FIG. 37 illustrates a spacer 600 for use with either the first embodiment of the lower pivot assembly 32 or the second embodiment of the lower pivot assembly 32a, although the spacer 600 is shown for use with the first embodiment of the lower pivot assembly 32. The spacer 600 is used to space the lower pivot assembly 32, 32a from the wall 16 of the vehicle 10 for spacing over trim or other projections connected to the wall 16 of the vehicle 10. The spacer 600 is configured to be positioned between the fixed part 136, 136a of the lower pivot assembly 32, 32a and the wall 16 of the vehicle 10. The spacer 600 (see FIG. 38) is a block of material having a plurality of holes 602 therethrough for accepting the fasteners 162, 162a therethrough to trap the spacer 600 between the fixed part 136, 136a of the lower pivot assembly 32, 32a and the wall 16 of the vehicle 10.

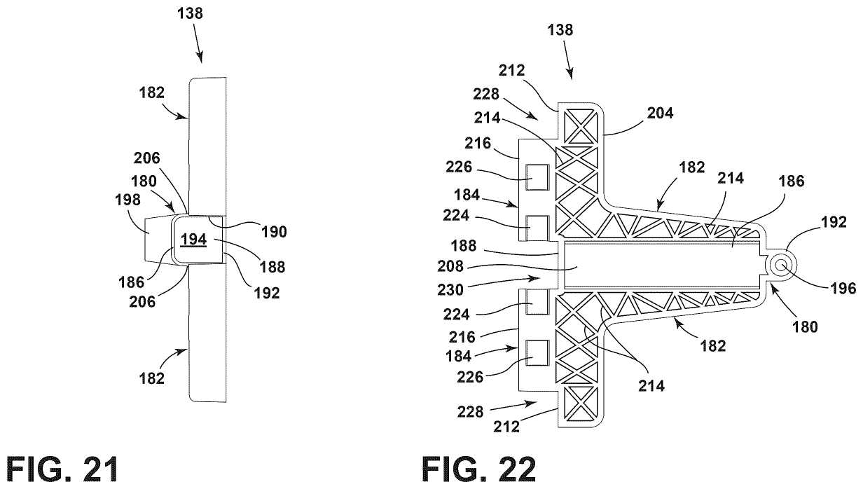

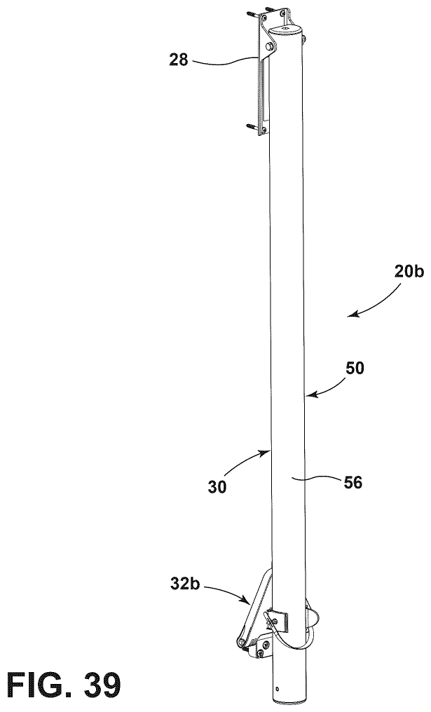

FIG. 39 illustrates a third embodiment of the retractable handle 20b. The third embodiment of the retractable handle 20b includes a third embodiment of the lower pivot assembly 32b, but the remaining elements of the third embodiment of the retractable handle 20b can be identical to the elements of the second embodiment of the retractable handle 20a as illustrated in FIGS. 20-36. Therefore, the third embodiment of the retractable handle 20b can include the rail assembly 26, the upper pivot assembly 28 and the support tube assembly 30 of the first embodiment of the retractable handle 20 as illustrated in FIGS. 1-19.

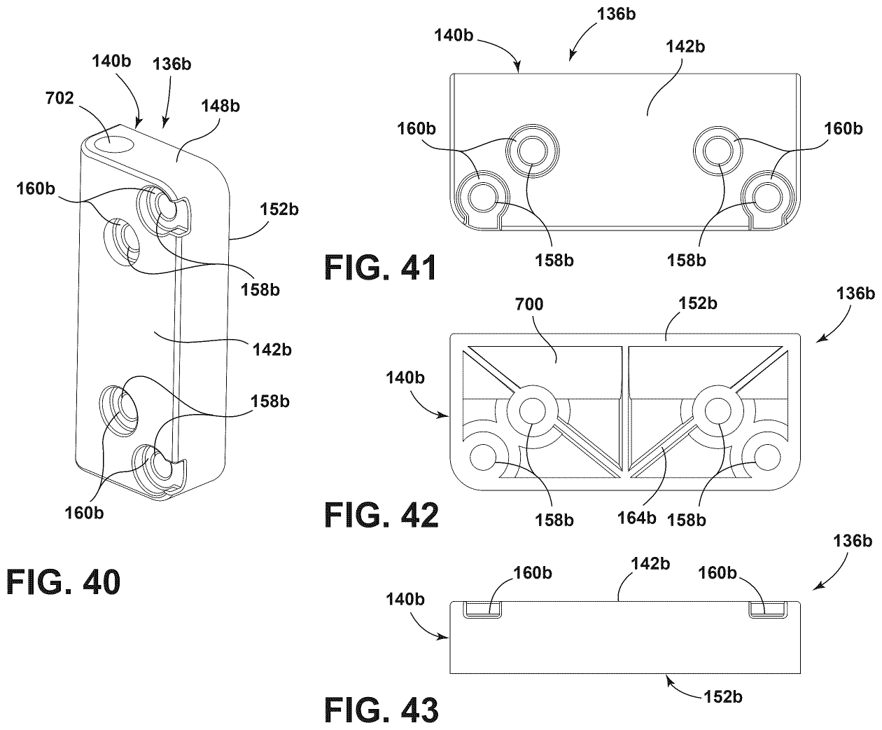

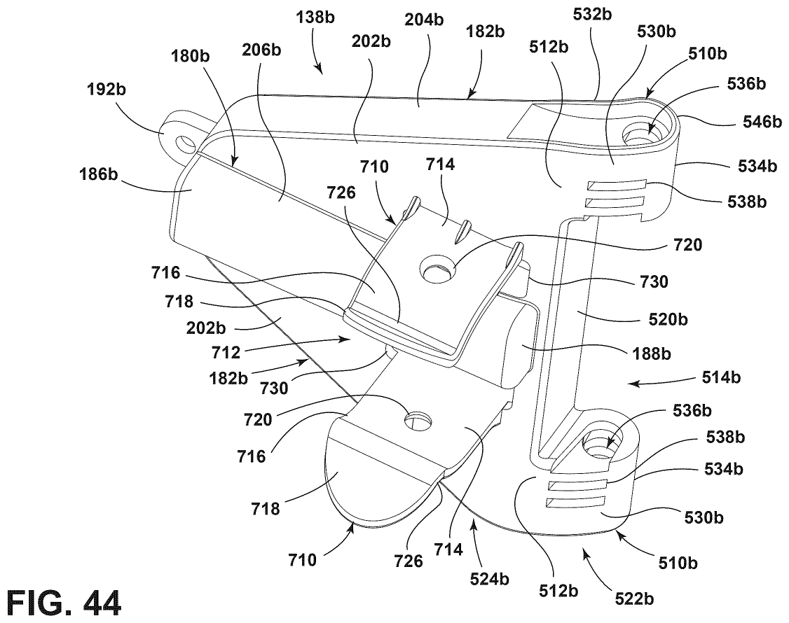

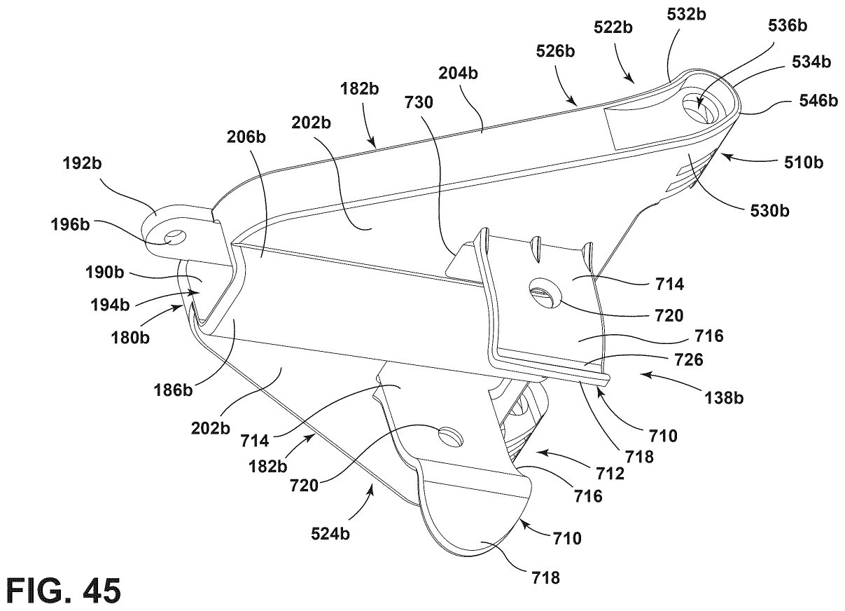

The illustrated third embodiment of the lower pivot assembly 32b includes a fixed part 136b (see FIGS. 40-43) connected to the wall 16 and a movable part 138b (see FIGS. 44-49) connected to the support tube assembly 30. The movable part 138b is rotatably connected to the fixed part 136b. The fixed part 136b and the movable part 138b can be formed from any material and in any manner (e.g., injection molded metal or plastic).

In the illustrated example, the fixed part 136b of the lower pivot assembly 32b is connected to the wall 16. The fixed part 136b comprises a substantially rectangularly shaped body 140b as shown in FIG. 41. The body 140b includes a substantially rectangularly shaped front plate 142b. An outer peripheral rim 148b extends downwardly from an outer peripheral edge of the front plate 142b. As shown in FIGS. 42 and 43, a bottom free edge 152b of the peripheral rim 148b is level for placement against the wall 16. A plurality of fastener cylinders 158b extend downwardly from counterbores 160b in the rectangularly shaped front plate 142b. Fasteners extend through the fastener cylinders 158b and into the wall 16 to connect the fixed part 136b to the wall 16, with heads of the fasteners being positioned in the counterbores 160b.

The illustrated fixed part 136b is configured to be rotatably connected to the movable part 138b. A lateral pivot tube 700 extends through the fixed part 136b in a direction substantially perpendicular to the fastener cylinders 158b. The lateral pivot tube 700 has openings 702 in opposite sides of the outer peripheral rim 148b. The fixed part 136b further includes a plurality of struts 164b extending between the peripheral rim 148b, the fastener cylinders 158b and the lateral pivot tube 700 to provide stability to the fixed part 136b.

In the illustrated example, the movable part 138b (FIGS. 44-48) of the lower pivot assembly 32b is connected to the support tube 90 of the support tube assembly 30 and to the fixed part 136b of the lower pivot assembly 32b. The movable part 138b includes a tube receiver portion 180b, a pair of triangular wing portions 182b and a pair of outer connection portions 510b. The tube receiver portion 180b receives the support tube 90 of the support tube assembly 30, the pair of outer connection portions 510b are connected to the fixed part 136b, and the pair of triangular wing portions 182b are located between the tube receiver portion 180b and the pair of outer connection portions 510b.

The illustrated tube receiver portion 180b of the movable part 138b connects the movable part 138b to the support tube 90 of the support tube assembly 30. The tube receiver portion 180b includes a tubular section 186b having a closed bottom 188b. An interior periphery 190b of the tubular section 186b can conform to the exterior shape of the support tube 90. The tubular section 186b can receive the bottom end 96 of the support tube 90 therein until the support tube 90 abuts the closed bottom 188b. The tube receiver portion 180b includes a connection tab 192b extending from the tubular section 186b adjacent an open mouth 194b of the tubular section 186b. Once the support tube 90 is fully inserted into the tubular section 186b, a fastener can be inserted through an aperture 196b of the connection tab 192b and into the support tube 90 to lock the support tube 90 into the tube receiver portion 180b of the movable part 138b. A lock clip 710 extends upwardly from each of the triangular wing portions 182b on each side of the tubular section 186b. As discussed below, the lock clips 710 form a receiving area 712 adapted to receive the grip piece 56 of the rail rod 50 of the support tube assembly 30 therein to lock the retractable handle 20b in the stowed position.

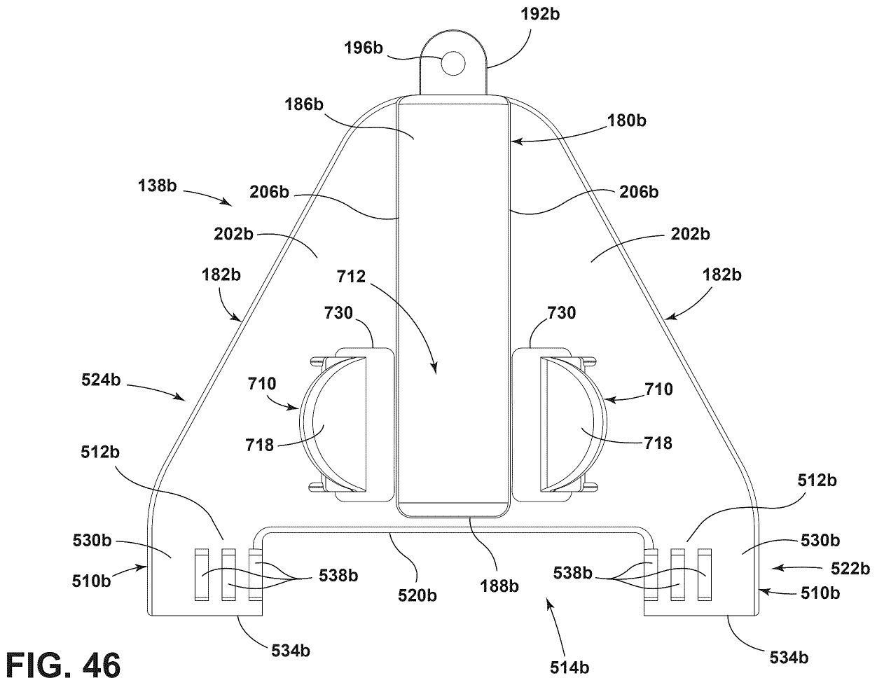

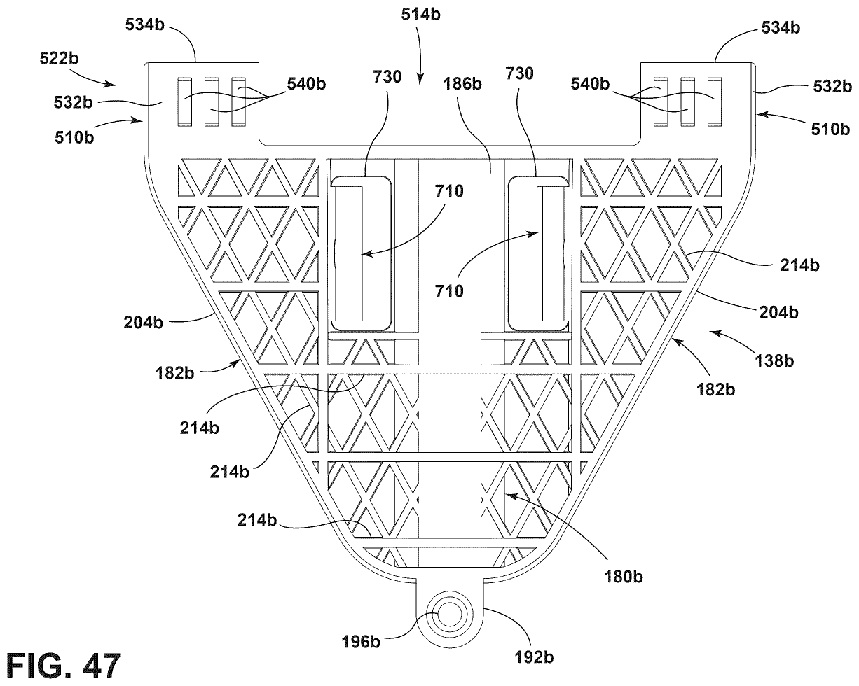

In the illustrated example, the pair of triangular wing portions 182b connect the tube receiver portion 180b to the pair of outer connection portions 510b. Each of the pair of triangular wing portions 182b include a triangular top plate 202b connected to a side face 206b of the tubular section 186b of the tube receiver portion 180b. A peripheral rim 204b extends downwardly from a periphery edge of each outside edge of the triangular top plate 202b. The outer connection portions 510b extend outward and downward from a lower edge 512b of each of the triangular wing portions 182b. An inner receiver area 514b is located between the outer connection portions 510b. An inner vertical wall 520b extends between the outer connection portions 510b as shown in FIGS. 44 and 46. As shown in FIG. 47, a plurality of struts 214b can extend rearwardly from the triangular top plate 202b.

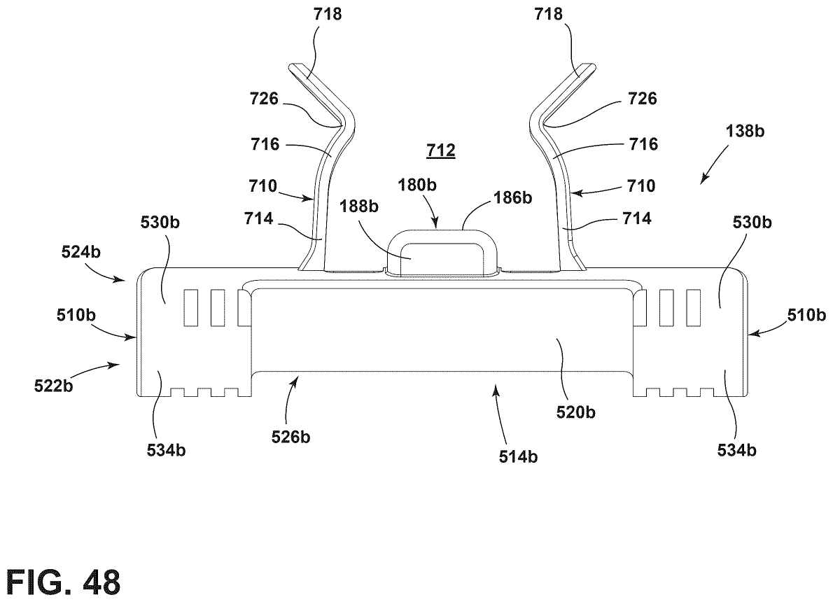

The illustrated movable part 138b includes a stepped configuration for mounting over trim or other projections connected to the wall 16 of the vehicle 10. The movable part 138b therefore includes a lower portion 522b that connects to the fixed part 136b, which is flush with the wall 16. The movable part 138b also includes a raised portion 524b that is configured to be spaced from the wall 16 (or at least a part of the wall 16) that is parallel with the part of the wall 16 connected to the fixed part 136. The raised portion 524b of the movable part 138b includes the tube receiver portion 180b, the triangular wing portions 182b, the inner vertical wall 520b and the struts 214b extending between these portions. The lower portion 522b includes the pair of outer connection portions 510b. As shown in FIGS. 44 and 48, the pair of outer connection portions 510b are angled away from the raised portion 524b to create a clearance distance 526b. The clearance distance 526b spaces the raised portion 524b away from the wall 16 or over any trim (or anything else) on the wall 16.

In the illustrated example, the outer connection portions 510b are angled away from the raised portion 524b to create the clearance distance 526b. Each outer connection portion 510b includes an upper angled surface 530b, a lower angled surface 532b and an arcuate surface 534b therebetween. An opening 536b extends through each outer connection portion 510b. Upper cut outs 538b can be positioned in the upper angled surface 530b and extend into the opening 536b. Likewise, lower cut outs 540b can be positioned in the lower angled surface 532b and extend into the opening 536b. Each outer connection portion 510b also defines an outer arcuate peripheral rim 546b.

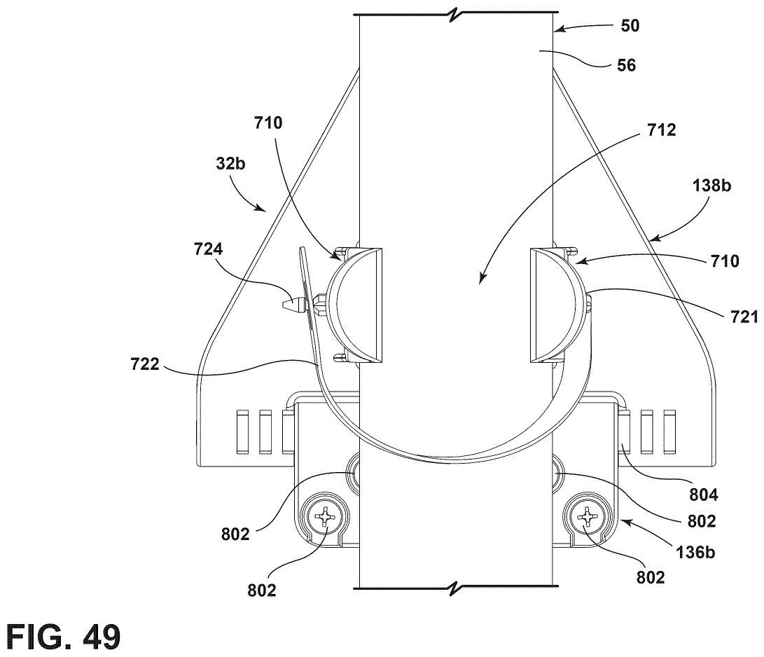

In the illustrated example, the fixed part 136b is rotatably connected to the movable part 138b. As illustrated in FIG. 49, the fixed part 136b is fixed to the wall 16 by inserting a plurality of fasteners 802 through the fastener cylinders 158b and into the wall 16. The fixed part 136 is located between the outer connection portions 510 of the movable part 138b in the inner receiver area 514b. A pivot pin 804 is inserted through the openings 536b of the movable part 138b and the lateral pivot tube 700 of the fixed part 136 to rotatably connect the movable part 138b to the fixed part 136b.

The illustrated movable part 138b includes the lock clips 710 that form the receiving area 712 adapted to receive the grip piece 56 of the rail rod 50 of the support tube assembly 30 therein to lock the retractable handle 20b in the stowed position as shown in FIGS. 39 and 49. Each of the lock clips 710 includes a straight portion 714 extending parallel to each other and perpendicularly from the triangular top plate 202b of triangular wing portions 182b, an inwardly curved portion 716 connected to an end of the straight portion 714 and an outwardly angled portion 718. The inwardly curved portions 716 of the lock clips 710 are angled toward each other, with the area between the straight portions 714 and the inwardly curved portions 716 defining the receiving area 712. It is contemplated that the triangular top plate 202b of the triangular wing portions 182b can include an opening 730 between the lock clips 710 and the tube receiver portion 180b for each of molding the movable part 138b and/or to save on material.

In the illustrated example, the lock clips 710 lock the grip piece 56 to the movable part 138b in the stowed position. As the retractable handle 20b is moved into the stowed position by moving the grip piece 56 towards the movable part 138b, the grip piece 56 will abut the outwardly angled portions 718 of the lock clips 710 to move the lock clips 710 away from each other to allow the grip piece 56 to move into the receiving area 712. Once the grip piece 56 is within the receiving area 712, the lock clips 710 move back towards each other to lock the grip piece 56 within the receiving area 712. It is further contemplated that a lock pin 721 can be inserted through holes 720 in the lock clips 710 and the lock hole 238 in the grip piece 56 as shown in FIG. 49 to prevent the grip piece 56 from leaving the receiving area 712. The lock pin 721 can include a strap 722 having a hole in an end thereof for receiving an end 724 of the lock pin 721 therein as shown in FIG. 49 to prevent the lock pin 721 from inadvertently being removed from the lock clips 710. It is also contemplated that alternatively or additionally a band (e.g., a rubber band) can be placed around each of the lock clips 710 to maintain the grip piece 56 within the receiving area 712, with the band being received in a notch 726 between the outwardly angled portion 718 and the inwardly curved portions 716 of each of the lock clips 710.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A retractable handrail comprising:
a rail assembly comprising a rail rod;
an upper pivot assembly pivotally connected to an upper end of the rail rod, the upper pivot assembly being configured to be connected to a support surface;
a lower pivot assembly configured to be connected to the support surface; and
a support shaft having a lower end pivotally connected to the lower pivot assembly, the support shaft including a slider at an upper end of the support shaft;
the slider being configured to slide within the rail assembly;
rotating the rail rod about the upper pivot assembly causes the slider to slide along the rail rod, thereby causing the support shaft to rotate about the lower pivot assembly;
the slider being configured to be selectively fixed in a deployed location relative to the rail assembly such that the rail assembly and the support shaft are fixed in a deployed position;
a lower end of the rail rod being configured to be spaced from the support surface in the deployed position to allow the rail assembly to be used as a handrest for people located adjacent to the retractable handrail;
the slider being configured to be located at an upper location relative to the rail assembly to position the retractable handrail in a stowed position;
the lower pivot assembly including a fixed part configured to be connected to the support surface; and
the fixed part of the lower pivot assembly including a pair of grip arms defining a receiving area therebetween, the receiving area receiving the support shaft therein when the retractable handrail is in the stowed position, the pair of grip arms configured to be resiliently moved away from each other to allow the support shaft to move into and out of the receiving area, the pair of grip arms maintaining the support shaft in the receiving area when the retractable handrail is in the stowed position.

2. The retractable handrail according to claim 1, wherein:
the lower pivot assembly further includes a movable part connected to the support shaft, with the fixed part being pivotally connected to the movable part.

3. The retractable handrail according to claim 2, wherein:
the movable part and the fixed part of the lower pivot assembly includes a plurality of interlocking connection blocks, with at least one of the movable part and the fixed part having at least two of the plurality of interlocking connection blocks, a pivot pin extending through the plurality of interlocking connection blocks to allow the movable part to rotate relative to the fixed part about an axis of rotation; and
the movable part of the lower pivot assembly is stepped such that a central longitudinal center line of the support shaft does not pass through the pivot pin.

4. The retractable handrail according to claim 3, wherein:
the movable part of the lower pivot assembly includes a receiving tube receiving the support shaft therein, the movable part including a curved area between the pivot pin and the receiving tube to form a step such that the central longitudinal center line of the support shaft does not pass through the pivot pin.

5. The retractable handrail according to claim 2, wherein:
the movable part and the fixed part of the lower pivot assembly includes a plurality of interlocking connection blocks with a pivot pin extending through the plurality of interlocking connection blocks to allow the movable part to rotate relative to the fixed part.

6. The retractable handrail according to claim 5, wherein:
the movable part includes one of the plurality of interlocking connection blocks and the fixed part having two of the plurality of interlocking connection blocks, with the one of the plurality of interlocking connection blocks of the fixed part being located between the two of the plurality of interlocking connection blocks of the movable part.

7. The retractable handrail according to claim 1, wherein:
the movable part of the lower pivot assembly includes a receiving tube receiving the support shaft therein; and
the pair of grip arms are located on opposite sides of the receiving tube.

8. The retractable handrail according to claim 1, wherein:
the pair of grip arms include a pair of aligned holes therethrough for allowing a lock pin to be inserted through the pair of aligned holes and the support shaft to lock the support shaft in the receiving area.

9. The retractable handrail according to claim 1, wherein:
the pair of grip arms include aligned notches, wherein the notches are configured to receive a band therein and around the pair of grip arms to prevent the support shaft from leaving the receiving area.

10. A retractable handrail comprising:
a rail assembly comprising a rail rod;
an upper pivot assembly pivotally connected to an upper end of the rail rod, the upper pivot assembly being configured to be connected to a support surface;
a lower pivot assembly configured to be connected to the support surface; and
a support shaft having a lower end pivotally connected to the lower pivot assembly, the support shaft including a slider at an upper end of the support shaft;
the slider being configured to slide within the rail assembly;
rotating the rail rod about the upper pivot assembly causes the slider to slide along the rail rod, thereby causing the support shaft to rotate about the lower pivot assembly;
the slider being configured to be selectively fixed in a deployed location relative to the rail assembly such that the rail assembly and the support shaft are fixed in a deployed position;
a lower end of the rail rod being configured to be spaced from the support surface in the deployed position to allow the rail assembly to be used as a handrest for people located adjacent to the retractable handrail;
the slider being configured to be located at an upper location relative to the rail assembly to position the retractable handrail in a stowed position;
the lower pivot assembly including a fixed part configured to be connected to the support surface and a movable part connected to the support shaft, with the fixed part being pivotally connected to the movable part; and
the movable part and the fixed part of the lower pivot assembly including a plurality of interlocking connection blocks, with at least one of the movable part and the fixed part having at least two of the plurality of interlocking connection blocks, a pivot pin extending through the plurality of interlocking connection blocks to allow the movable part to rotate relative to the fixed part about an axis of rotation; and
the movable part of the lower pivot assembly is stepped such that a central longitudinal center line of the support shaft does not pass through the pivot pin.

11. The retractable handrail according to claim 10, wherein:
the movable part includes one of the plurality of interlocking connection blocks and the fixed part having two of the plurality of interlocking connection blocks, with the one of the plurality of interlocking connection blocks of the fixed part being located between the two of the plurality of interlocking connection blocks of the movable part.

12. The retractable handrail according to claim 11, wherein:
the fixed part of the lower pivot assembly includes a pair of grip arms defining a receiving area therebetween, the receiving area receiving the support shaft therein when the retractable handrail is in the stowed position, the pair of grip arms configured to be resiliently moved away from each other to allow the support shaft to move into and out of the receiving area, the pair of grip arms maintaining the support shaft in the receiving area when the retractable handrail is in the stowed position.

13. The retractable handrail according to claim 12, wherein:
the movable part of the lower pivot assembly includes a receiving tube receiving the support shaft therein; and
the pair of grip arms are located on opposite sides of the receiving tube.

14. The retractable handrail according to claim 12, wherein:
the pair of grip arms include a pair of aligned holes therethrough for allowing a lock pin to be inserted through the pair of aligned holes and the support shaft to lock the support shaft in the receiving area.

15. The retractable handrail according to claim 12, wherein:
the pair of grip arms include aligned notches, wherein the notches are configured to receive a band therein and around the pair of grip arms to prevent the support shaft from leaving the receiving area.

16. A retractable handrail comprising:
a rail assembly comprising a rail rod;
an upper pivot assembly pivotally connected to an upper end of the rail rod, the upper pivot assembly being configured to be connected to a support surface;
a lower pivot assembly configured to be connected to the support surface; and
a support shaft having a lower end pivotally connected to the lower pivot assembly, the support shaft including a slider at an upper end of the support shaft;
the slider being configured to slide within the rail assembly;
rotating the rail rod about the upper pivot assembly causes the slider to slide along the rail rod, thereby causing the support shaft to rotate about the lower pivot assembly;
the slider being configured to be selectively fixed in a deployed location relative to the rail assembly such that the rail assembly and the support shaft are fixed in a deployed position;
a lower end of the rail rod being configured to be spaced from the support surface in the deployed position to allow the rail assembly to be used as a handrest for people located adjacent to the retractable handrail;
the slider being configured to be located at an upper location relative to the rail assembly to position the retractable handrail in a stowed position;
the lower pivot assembly including a fixed part configured to be connected to the support surface and a movable part connected to the support shaft, with the fixed part being pivotally connected to the movable part; and
the movable part and the fixed part of the lower pivot assembly including a plurality of interlocking connection blocks with a pivot pin extending through the plurality of interlocking connection blocks to allow the movable part to rotate relative to the fixed part, with the movable part including one of the plurality of interlocking connection blocks and the fixed part having two of the plurality of interlocking connection blocks, with the one of the plurality of interlocking connection blocks of the fixed part being located between the two of the plurality of interlocking connection blocks of the movable part.

17. The retractable handrail according to claim 16, wherein:
the fixed part of the lower pivot assembly includes a pair of grip arms defining a receiving area therebetween, the receiving area receiving the support shaft therein when the retractable handrail is in the stowed position, the pair of grip arms configured to be resiliently moved away from each other to allow the support shaft to move into and out of the receiving area, the pair of grip arms maintaining the support shaft in the receiving area when the retractable handrail is in the stowed position.

18. The retractable handrail according to claim 17, wherein:
the movable part of the lower pivot assembly includes a receiving tube receiving the support shaft therein; and
the pair of grip arms are located on opposite sides of the receiving tube.

19. The retractable handrail according to claim 17, wherein:
the pair of grip arms include a pair of aligned holes therethrough for allowing a lock pin to be inserted through the pair of aligned holes and the support shaft to lock the support shaft in the receiving area.

20. The retractable handrail according to claim 17, wherein:
the pair of grip arms include aligned notches, wherein the notches are configured to receive a band therein and around the pair of grip arms to prevent the support shaft from leaving the receiving area.
